(19) United States
(12) Patent Application Publication
(10) Pub. No.: US 2005/0105520 A1
(43) Pub. Date: May 19, 2005

(54) Quality of service consistency checker in traffic splitter arrangement

(76) Inventors: Emil Tiller, Adelaide (AU); Chee Kent Lam, Adelaide (AU)

Correspondence Address: AKERMAN SENTERFITT, P.O. BOX 3188, WEST PALM BEACH, FL, 33402-3188, US

(21) Appl. No.: 10/497,044

(22) PCT Filed: Nov. 29, 2002
(86) PCT No.: PCT/AU02/01617

(30) Foreign Application Priority Data
Nov. 30, 2001 (AU) PR 9183

(51) Int. Cl. H04L 12/28; H04L 12/56; G06N 5/02; G06F 17/00

(52) U.S. Cl. 370/389; 370/395.21; 706/47

(57) ABSTRACT

A method checking for ambiguity the definition of channels in a channel splitting arrangement, such channels being defined by a set of rules. The method includes associating a mark with each of the rules, breaking each rule down into sub-rules so that each sub-rule has one or more operators selected only from the following Boolean operators AND, equality or negation including any number of uses of these in the same sub-rule, the parent rules being able to be expressed by combining sub-rules using OR Boolean operators, each sub-rule being associated with the mark associated with the respective parent rule.

### TECHNICAL FIELD

This invention relates to consistency checking of a traffic splitter in a packet switching arrangement.

### BACKGROUND ART

Traffic splitters are known in packet switching systems. They are used to divide an incoming flow of packets into logical channels. Channels are the flow of information between logical endpoints. Each channel is defined by a rule as to the value of one or more parameters of the packet. Typical parameters which may be used to differentiate channels are source address, destination address, source port, destination port and protocol, but others may be used. Traffic splitters may be used in such sub-systems of a packet switching system as firewalls and quality of service guarantee arrangements.

In most traffic splitters, rules are traversed by an incoming packet in order until a match is found. The matching rule defines the channel. Typically no checks are done to see if one rule blocks another rule from being executed. For example, if rule 1 says match packets going to destination address 10.128.0.1 and rule 2 says match packets going to destination port 80, then a packet going to destination address 10.128.0.1 and to destination port 80 will match rule 1. Rule 2 will never be reached. In a complex system with many rules, this may not be the intention of the user. It would be an advantage if the user could be made aware of this and allowed to explicitly choose the precedence order of the rules.

A further disadvantage of this arrangement is that it is impossible to know if the order of traversal of the rules is significant, so the order must be preserved in all cases. This severely limits the possibilities for using advanced mathematical tools to improve the efficiency of the allocation of packets to channels.

### DISCLOSURE OF THE INVENTION

It is an object of this invention to provide a method and means to effect a checking of a set of traffic splitting rules and to enable then a user of an ambiguity or at least to provide the public with a useful alternative.

In one form of the invention this can be said to reside in a method of effecting a checking for ambiguity of a definition of a plurality of channels in a channel splitting arrangement, such channels being defined by a set of rules incorporated in said arrangement, the method including these steps:
associating a mark with each of a plurality of parent rules,
breaking each rule down into sub-rules so that each sub-rule has one
   or more operators selected only from the following Boolean operators AND, equality or negation including any number of uses of these in the same sub-rule, the parent rules being able to be expressed by combining sub-rules using OR Boolean operators, each sub-rule being associated with the mark associated with the respective parent rule.

In a further form of the invention this can be said to reside in a method of effecting a checking for ambiguity of a definition of a plurality of channels in a channel splitting arrangement, such channels being defined by a set of rules incorporated in said arrangement, the method including these steps:
associating a mark with each of a plurality of parent rules,
breaking each rule down into sub-rules so that each sub-rule has one
   or more operators selected only from the following Boolean operators AND, equality or negation including any number of uses of these in the same sub-rule, the parent rules being able to be expressed by combining sub-rules using OR Boolean operators, each sub-rule being associated with the mark associated with the respective parent rule, entering each of the sub-rules into a data structure, said structure having a branching arrangement wherein each node is an equality or negated equality clause of a sub-rule, and each link between nodes is an AND operator from a sub-rule wherein also nodes which by virtue of their position in the structure can be reached only by traversing all the nodes which constitute the clauses of a sub-rule also containing the mark associated with that sub-rule, creating a packet from each sub-rule, with that packet having parameters set such that the packet will meet the requirements of that sub-rule, with all other possible parameters set to a value indicating non-significance, then having each packet traverse the data structure, only continuing to traverse links from a node if the values of the parameters within the packet meet the terms of that sub-rule clause and it being arranged so that if the node contains a mark, and the packet meets the terms of the sub-rule clause within that node, then the mark is associated with the packet such that if a packet results with more than one mark which could indicate an ambiguity between the rules associated with those marks these rules can then be respecified to remove the ambiguity, or have differing assigned priorities.

In preference, the method further includes the step of removing a given rule from the data structure after the packet created from said rule has traversed the structure.

In preference, the method further includes the step selecting the order in which packets created from the rules traverse the data structure by use of a weighting factor such factor being the sum of terms each term being a number created by the bitwise inversion of the mask associated with a parameter of the rule, divided by a selected factor.

In preference, the invention may be said to reside in a traffic splitting arrangement for a packet switching system, wherein the logic defined in the rules of operation have been checked by the method as above.

### BRIEF DESCRIPTION OF THE DRAWINGS

For a better understanding of the invention it will now be described with relation to a preferred embodiment which is described with the assistance of drawings wherein:

FIG. 1 shows a high level system diagram of a system that needs to split traffic into various logical flows of packets (channels).

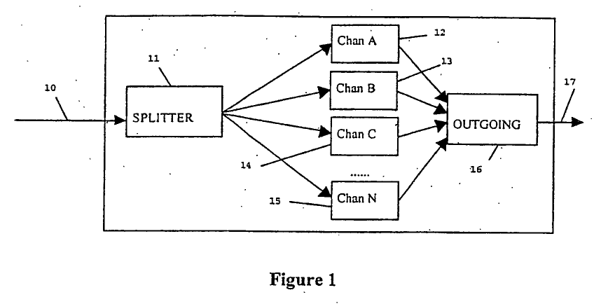

FIG. 2 shows an example representation of a set of rules that split traffic in a data structure.

FIG. 3 shows the same example representation of rules as in FIG. 2 but with one of the rules removed.

FIG. 4 shows the same example representation of rules as in FIG. 3 but with one of the rules removed.

FIG. 5 shows a psuedocode description of the data structure into which the rules are placed.

FIG. 6 shows a psuedocode description of the data structure traversal algorithm.

### BEST METHOD OF PERFORMANCE

A typical system will have a series of rules for splitting traffic based on the various configurations of parameters in each rule into logical flows of packets known as channels. For example, rule 1 may split traffic out such that everything going to destination address 10.128.0.10 goes into channel 1 and rule 2 may split traffic out such that everything coming from source address 10.128.0.55 goes to channel 2. This example highlights an inconsistency in the traffic splitting rules. If a packet were to enter the system going to destination address 10.128.0.10 and coming from source address 10.128.0.55 then the system would be equally correct in choosing to place the packet into channel 1 or channel 2. This represents an inconsistency to be resolved. To resolve it, the user setting up the rules can either choose a precedence to be associated with the rules or can re-write the rules such that they are not in an inconsistent state.

The consistency check proceeds as follows. A mark is determined for each rule. For example, rule 1 above may be given the mark 1 and rule 2 may be given the mark 2. The rules are then broken down into a consistent format such that they can be entered into a data structure. Each sub rule forms a node in the data structure.

A packet of parameters and masks is then created from each sub rule, with only the parameters and masks mentioned in that sub rule defined, and defined with the values which would meet that sub rule. Each packet is then passed through the data structure and each time it encounters a node within the data structure that would match the packet, the mark appropriate to that node is placed within a set inside the packet. If, at the end of this process, a packet contains more than one mark in its mark set, then there has been a conflict between the corresponding rules in the set and this is notified to the user.

The rule from which the packet of parameters and masks was created is then removed from the system and the process repeats for the next rule. The order in which the rules are removed has an impact on the speed in which the system can do an exhaustive search of all possible conflicts. A simple heuristic can be determined to speed this process up without impacting the complexity of the algorithm.

When a packet enters the traffic splitting system, that packet will have a number of different parameters that may be used to determine which channel the packet belongs to. Some examples are source address, destination address, source port, destination port and protocol but the system is not restricted to only these. Each packet is examined to see if it matches a traffic splitting rule to determine which channel it should go into. If a packet matches two rules, then there is a conflict and the user or administrator of the system can either change the rule to not conflict or place a precedence on the rule.

For example, consider the following example:
rule for channel A: destination address=10.128.0.1 && destination port=80
rule for channel B: destination port=80

This represents a conflict when a packet destined for address 10.128.0.1 and destination port 80 comes into the system. The rule for channel A matches as well as the rule for channel B. The system administrator or user therefore needs to specify a precedence on at least one of the rules to specify which one should be chosen in preference to the other when there is a conflict.

The system flags the following conditions for user intervention:
when a rule has an unresolvable conflict (for example, rule: destination address=10.128.0.1 && destination address=10.128.0.2)
when two rules without precedence specified conflict
if two rules have been specified with the same precedence conflict

The operators that are applicable to a rule are as follows:
a ==b (equals)
a !=b (not equals)
a && b or a [symbol] b (and)
a ∥ b or a [symbol] b (or)
!a or [symbol] a (not)
( )(grouping)

As an example, consider the following rule:
(destination address ==10.128.0.1/255.255.255.255 && source address !=10.128.0.10/255,255.255.255) ∥ !((destination port ==80) && (source port ==50))

This rule says: Match the packet if the destination address equals 10.128.0.1 with mask 255.255.255.255 and the source address does not equal 10.128.0.10 with mask 255.255.255.255 or if the destination port does not equal 80 or source port does not equal 50.

Each rule in the system has a unique mark. This simply means giving each rule a unique integer identifier. Rules that have a precedence assigned to them are remembered for later since a rule that has a precedence does not produce a conflict with another rule with a different precedence.

Each rule now needs to be broken into smaller rules so that they can fit easily into a data structure that will allow quick traversal of rules. Consider the following rule:
Rule 1: ((A1==W1/WM1 && A2==W2/WM2 && . . . ) &&!(B1==X1/XM1 && B2==X2/XM2 && . . . ))∥((C1 ==Y1/YM1 && C2=Y2/YM2 && . . . )&&!(D1==Z1/ZM1 && D2==Z2/ZM2 && . . . ))∥. . .

If we were to mark this with the value 1, then we can break this super rule into separate rules called sub rules that each mark the packet with the value 1 if the sub rule is found to be true:
Rule 1a: (A1==W1/WM1 && A2=W2/WM2 && . . . ) &&!(B1==X1/XM1 && B2==X2/XM2 && . . . )—mark with value 1
Rule 1b: (C1==Y1/YM1 && C2==Y2/YM2 && . . . )&&!(D1==Z1/ZM1 && D2==Z2/ZM2 && . . . )—mark with value 1

Now, any packet entering the system and marked with the value 1 applies to Rule 1 (whether it was marked by rule 1a, rule 1b, . . . ).

Formally, the format of a sub rules is:

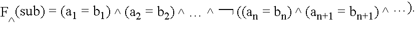

The format of the super rule is:

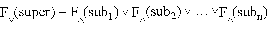

Any equation using the operations previously described can be manipulated into this format using the following rules of boolean algebra applied recursively:
F(a) [symbol] (F(b) [symbol] F(c)) [symbol] (F(a) [symbol] F(b)) [symbol] (F(a) [symbol] F(c))
F(a) [symbol] (F(b) [symbol] F(c)) [symbol] (F(a) [symbol] F(b)) [symbol] (F(a) [symbol] F(c)) [symbol]
(F(a) [symbol] F(b)) [symbol] [symbol] F(a) [symbol] [symbol] F(b) [symbol]
(F(a) [symbol] F(b)) [symbol] [symbol] F(a) [symbol] [symbol] F(b)
(F(a) [symbol] F(a)) [symbol] F(a)
a₁!=a₂ [symbol] [symbol] a₁=a₂

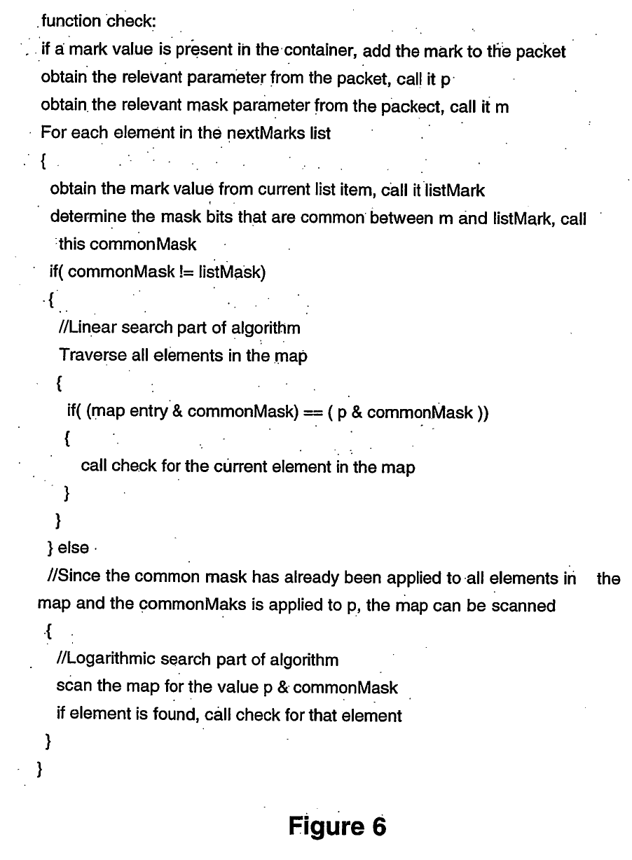

Once all of the rules have been described, they are entered into a data structure. In pseudocode, this data structure appears in FIG. 6.

Referring to FIG. 6 mark is the mark that a packet will have placed on it if it matches a rule; nextMarks contains a list of masks and their associated maps into a pointer to a next_marker. A mask is the binary string that is ANDed with a parameter before going through the map; notEqual is the list of rules that need to be checked to make sure they do not occur before being able to say if a packet matches a rule. If a mark value is found, this list is traversed to make sure that none of the parameters match. If a match is found, the packet cannot be marked.

For illustration purposes, let us say that a packet has only two parameters that we can use to classify it: destination address and source address, both of which are 32 bits each.

An example set of rules is shown below. Assume that all addresses are specified in 4 bit binary. Addresses and masks are specified in the format address/mask.
Rule 1: destination address=1100/1111 && source address=1101/1111−mark 1
Rule 2: destination address=1110/1110 && source address=1010/1111−mark 2
Rule 3: destination address=1000/1100 && source address 1011/1111−mark 3
Rule 4: destination address=1100/1111 && source address=1010/1111−mark 4
Rule 5: destination address=1100/1110 && source address=1101/1111−mark 5
Rule 6: destination address=1001/1111

As can be seen, rules 1 and 5 conflict—if a packet with destination address=1100 and source address 1101 comes into the system, both rules match.

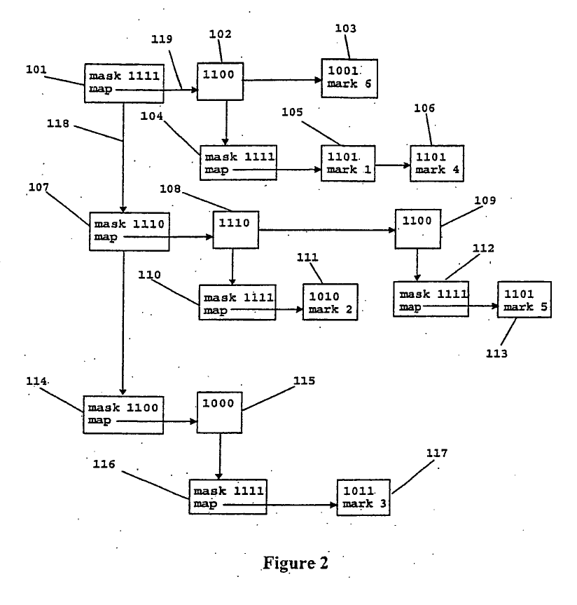

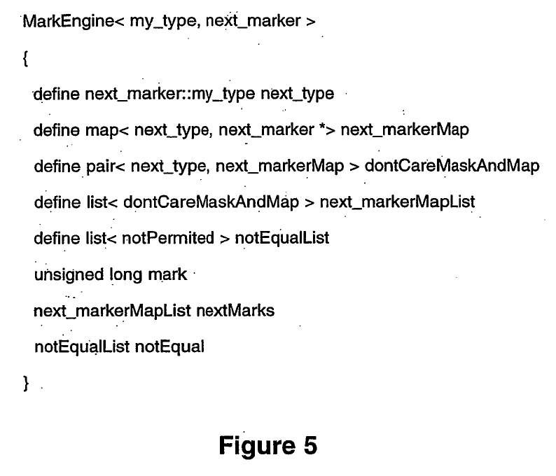

FIG. 2 represents the data structure as described by the pseudo-code fragment if FIG. 5.

101 is an element of TopLevel. 101 is the first element in a list of masks and associated maps. 118 is the next pointer in the list and 107 is the next element in the list. 119 represents the first link in the map of elements. 102 is of type DestinationAddress. If a packet with a destination address equal to 1100 is placed into the system, it will visit this element. It also contains a list of masks and associated maps as well. The first element in the list is 104. 103 is of type DestinationAddress as well. If a packet visits this node during traversal, a mark of 6 shall be added to the mark set of the packet. 105 is the first element of the map associated with 104. It is of type SourceAddress. Any packet visiting this node shall have a mark of 1 added to it. 106 is also of type SourceAddress and any packet visiting this node shall have a of 4 added to it. 107 is the second element in the list of masks and associated maps in TopLevel. It contains the map of elements to match for a mask of 1110. 108 is of type DestinationAddress. It will be visited for packets with DestinationAddress 1110 and 1111 since the mask is 1110. 109 is also of type DestinationAddress and will be visited for packets with DestinationAddress 1100 and 1101. 110 is the first element in the list of masks and maps associated with the DestinationAddress element 108. 111 is of type SourceAddress and will mark packets with the value 2. This will occur if the DestinationAddress is 1110 or 1111 and the SourceAddress is 1010. 112 is the first element in the list of masks and maps associated with the DestinationAddress element 109.113 is of type SourceAddress and will mark packets with the value 5. This will occur if the DestinationAddress is 1100 or 1101 and the SourceAddress is 1101. 114 is the last element in the list of masks and maps associated with TopLevel. 115 is of type DestinationAddress. 116 is the first element in the mask and map list associated with 115 and 117 is of type SourceAddress and will mark packets with the value 3 if it is visited.

For each rule, a packet is created that will be able to traverse the data structure shown in FIG. 2 and determine if it conflicts with any other rules. The packet will contain information for each parameter that has been used within the aforementioned data structure. In the example, each packet will need:
Destination address and mask
Source address and mask

In general, the number of parameters is not restricted.

Each packet will then pass through the system and will be marked for each node that it hits that has a mark. If it has no conflicts, it will have only one number—the mark value for that rule itself. If there are conflicts, it will have multiple marks and these marks all conflict with one another. If the marks have different priorities associated with them, they are not considered to conflict. After the packet has traversed the system, the rule that makes the packet can be removed since that rule has been accounted for in the context of all other rules.

The traversal algorithm is shown in FIG. 6, starting at TopLevel.

It is useful to get the order in which the rules are traversed correct. In the traversal algorithm shown in FIG. 6, there are two sections—one that traverses the elements linearly and one that traverses them logarithmically (through a map). It is therefore usefult to choose the order in which packets go through the system to minimize the amount of linear searching. Since there is an ordering in which the data structure is built up, the linear search of elements higher in the data structure should be eliminated first. To do this, a weighting function is used to classify which rules should be traversed and then removed.

First, the order in which the data structure is built is be determined. In the example above, we chose the order:
Destination Address
Source Address

Assume p1 . . . pn represents the different parameters (for example, Source Address and Destination Address) in the system and that the data structure is built in the order p1 . . . pn (in our example, it goes TopLevel->DestinationAddress->SourceAddress). Associated with each p1 . . . pn is a mask, call it m1 . . . mn. Let us assume that a mask starts with a 1 in the most significant bit and consists of consecutive 1's moving towards the least significant bit. For example, the following two masks are valid (assuming masks are 4 bits wide):
1100
1110

However, the following masks are not:
1010
1101

Let us say that we have the following masks in the nextMarks_list for DestinationAddress:
1111-6 elements in the map
1110-3 elements in the map
1100-2 elements in the map
0000-1 element in the map

We want to minimize the linear search component of the check algorithm. If we were to choose packets to search for from the elements in the maps associated with 1110, 1100 and 0000, they would all need to do linear searches on the map in the 1111 part of the list since 1110 & 1111 !=1111, 1100 & 1111 !=1111 and 0000 & 1111 !=1111 (hence commonMask !=listMask and the linear part of the algorithm is traversed). This is undesirable.

If instead we choose packets from the 1111 part of the list, the 6 packets would all use the map method of searching then would be removed from the system. If the 1110 packets were then used, since the 1111 rules had been removed, there would still be no need for a linear search. Thus, by ordering the packets well, the linear part of the search algorithm does not need to be used. Our objective is to therefore come up with a system whereby the least number of linear searches is done. One simple method of doing this is to calculate a weight based on the m1 . . . mn. The lower the weight, the more useful it is to remove the packet from the system in the interest of minimizing the number of linear searches done. The following function can be used to calculate this weight.
weight==˜m2/w1+˜m2/w2+ . . . +˜mn/wn

Where w1 . . . wn are generally in ascending order and are chosen to minimize the number of linear searches in the system. Thus we see the higher the mask value, that is the more bits of the mask are set, the lower the weight returned and the more likely it will be to be chosen to be removed. Generally, the mask associated with p1 is more of a weighting factor since it is useful that the upper layers of the data structure tree are removed first since they will be searched more regularly than those down in the tree hierarchy.

Choosing w1 to be 1 and w2 to be 10 we have the following weights for the 6 rules:
Rule 1: weight=0000+0000=0
Rule 2: weight=0001+0000=1
Rule 3: weight=0011+0000=3
Rule 4: weight=0000+0000=0
Rule 5: weight=0001+0000=1
Rule 6: weight=0000+0000=0

Thus, the order of packet traversal will be:
Rule 1, Rule 4, Rule 6, Rule 2, Rule 5, Rule 3.

We now pass the packets through the system to determine what conflicts there are. These conflicts are presented to the user and the user may then re-write the rule or set a precedence on the rules to avoid the conflict. The mechanism for doing this has been presented previously, so let us now examine packets for the various rules passing through the system to uncover conflicts. We will examine rule 1 and rule 4 passing through the system to show how the system is working.

We start with rule 1, which has the following packet: (destination address=1100 mask 1111, source address=1101 mask 1111).

From FIG. 2, we start at position 101. The destination address mask and list mask equal the list mask (1111 & 1111 ==1111), hence we can use the map method of searching for the map associated with position 101. This takes us to position 102. We follow this and go to position 104. The source address mask and list mask equal the list mask (1111 & 1111 ==1111) hence we can use the map method of searching. This takes us to position 105 and we mark the packet with the value 1. We have now exhausted this branch of the tree. We now move on to position 107. The destination address mask and list mask equals the list mask (1111 & 1110 ==1110) so we can once again use the map method of traversal. This brings us to position 109. We follow this and go to position 112. The source address mask and list mask equal the list mask (1111 & 1111=1111) so we can use the map method of traversal. This takes us to position 113 hence we mark the packet with the value 5. We have now exhausted this part of the tree and move on to position 114. The destination address mask and list mask equals the list mask (1111 & 1100=1100), so we can once again use the map method of traversal. There are no more matches.

Since the packet is marked with both 1 and 5, we can say that rules 1 and 5 conflict and report this to the user.

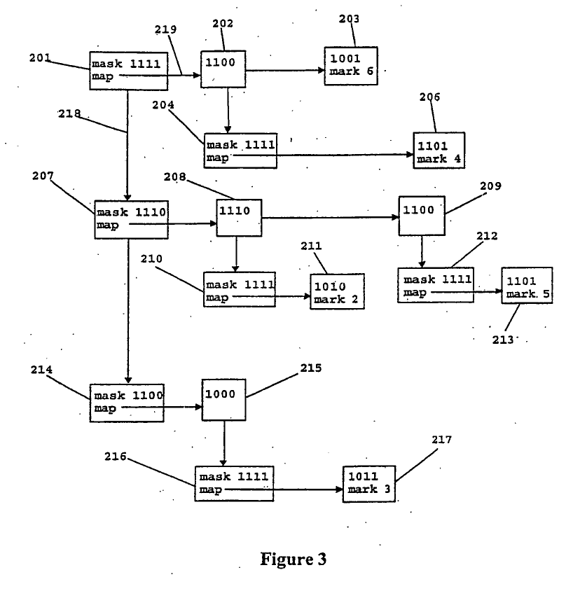

We now remove the rule from the system to get FIG. 3.

Note that the element between 204 and 206 is no longer present (previously 105 in FIG. 2). Now rule 1 has been removed, we can proceed with passing a packet from rule 4 through the system. This packet is of the form:
(destination address=1100 mask 1111, source address=1010 mask 1111)

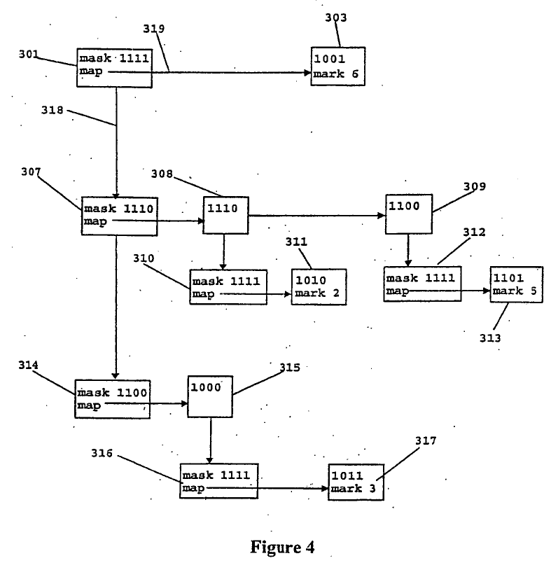

Using FIG. 3, we start at position 201. The destination mask and list mask equals the list mask (1111 & 1111 ==1111), hence we can use the map method of searching for the map associated with position 1. This takes us to position 202. We follow this and go to position 204. The source address mask and list mask equals the list mask (1111 & 1111 ==1111) hence we can use the map method of searching. This takes us to position 206 and we mark the packet with the value 4. We have now exhausted this branch of the tree. We now move on to position 207. The destination mask and list mask equals the list mask (1111 & 1110 ==1110) so we can once again use the map method of traversal. This brings us to position 209. We follow this and go to position 212. The source address mask and list mask equals the list mask (1111 & 1111=1111) so we can use the map method of traversal. There are no more matches and this part of the tree has been exhausted. We now move on to position 214. The destination address mask and list mask equals the list mask (1111 & 1100=1100), so we can once again use the map method of traversal. There are no more matches. Since we only found one match, there are no conflicts between rule 4 and the other rules. Rule 4 is then removed from the system which can be seen in FIG. 4. Note that since elements in position 205 and 206 have gone, elements in position 204 and 202 can be removed.

The other rules are then treated in the same manner. By going through them in a similar manner, it can be seen that the linear part of the check algorithm never needs to be executed and that the only conflict is between rule 1 and 5.

1. A method of effecting a checking for ambiguity of a definition of a plurality of channels in a channel splitting arrangement, such channels being defined by a set of rules incorporated in said arrangement, the method including these steps: associating a mark with each of a plurality of parent rules, breaking each rule down into sub-rules so that each sub-rule has one or more operators selected only from the following Boolean operators AND, equality or negation including any number of uses of these in the same sub-rule, the parent rules being able to be expressed by combining sub-rules using OR Boolean operators, each sub-rule being associated with the mark associated with the respective parent rule.

2. A method of effecting a checking for ambiguity of a definition of a plurality of channels in a channel splitting arrangement, such channels being defined by a set of rules incorporated in said arrangement, the method including these steps: associating a mark with each of a plurality of parent rules breaking each rule down into sub-rules so that each sub-rule has one or more operators selected only from the following Boolean operators AND, equality or negation including any number of uses of these in the same sub-rule, the parent rules being able to be expressed by combining sub-rules using OR Boolean operators, each sub-rule being associated with the mark associated with the respective parent rule, entering each of the sub-rules into a data structure, said structure having a branching arrangement wherein each node is an equality or negated equality clause of a sub-rule, and each link between nodes is an AND operator from a sub-rule wherein also nodes which by virtue of their position in the structure can be reached only by traversing all the nodes which constitute the clauses of a sub-rule also containing the mark associated with that sub-rule, creating a packet from each sub-rule, with that packet having parameters set such that the packet will meet the requirements of that sub-rule, with all other possible parameters set to a value indicating non-significance, then having each packet traverse the data structure, only continuing to traverse links from a node if the values of the parameters within the packet meet the terms of that sub-rule clause and it being arranged so that if the node contains a mark, and the packet meets the terms of the sub-rule clause within that node, then the mark is associated with the packet such that if a packet results with more than one mark which could indicate an ambiguity between the rules associated with those marks these rules can then be respecified to remove the ambiguity, or have differing assigned priorities.

3. A method of effecting a checking for ambiguity of a set of rules incorporated in a channel splitting arrangement as in claim 2 further including the step of removing a given rule from the data structure after the packet created from said rule has traversed the structure.

4. A method as in claim 3 further including the step of selecting the order in which packets created from the rules traverse the data structure by use of a weighting factor such factor being the sum of terms each term being a number created by the bitwise inversion of the mask associated with a parameter of the rule, divided by a selected factor.

5. A traffic splitting arrangement for a packet switching system, wherein the rules of operation have been checked by the method of claim 1.
